(19) United States
(12) Patent Application Publication
(10) Pub. No.: US 2012/0037795 A1
(43) Pub. Date: Feb. 16, 2012

(54) METHOD AND APPARATUSES FOR QUALITY EVALUATION AND LEAK TESTING

(76) Inventor: Martin LEHMANN, Wohlen (CH)

(21) Appl. No.: 12/869,492

(22) Filed: Aug. 26, 2010

(30) Foreign Application Priority Data
Aug. 10, 2010 (EP) 10172402.9

(51) Int. Cl. H01J 49/26; B65B 3/04; B65B 57/00

(52) U.S. Cl. 250/282; 53/467; 53/266.1; 250/288

(57) ABSTRACT

It is suggested to use mass spectroscopy in in-line testing of closed containers.

The method for evaluating a quality of a number of closed filled containers filled with a filling product comprises:

detecting at least one analyte by means of a mass spectroscopy technique, wherein said at least one analyte comprises at least one of
said filling product;
one or more components of said filling product;
a decomposition product of said filling product;
one or more decomposition products of one or more components of said filling product.

### TECHNICAL FIELD

The invention relates to the field of quality control and in particular leak testing. It relates to methods and apparatuses according to the opening clauses of the claims. Such methods and apparatuses find application, e.g., in food industry and pharmaceutical industry.

### BACKGROUND OF THE INVENTION

Various ways of evaluating the quality of closed filled containers are known in the art. E.g., tracer gases such as Nitrogen or Argon can be filled into the containers, in addition to the filled products, and then, a leakage rate for said tracer gas is determined. From said leakage rate, a leak rate for the filled product is then estimated.

### SUMMARY OF THE INVENTION

Therefore, one object of the invention is to create an alternative way of evaluating a quality of a closed filled container, in particular a leak tightness thereof.

In particular, the invention shall be applicable in-line in a production process.

Further objects emerge from the description and embodiments below.

At least one of these objects is at least partially achieved by apparatuses and methods and uses according to the patent claims.

It is suggested to use mass spectroscopy for detecting whether or not and to which extent said filling product has escaped from a closed filled container. This method is very specific and precise and very direct, at least when compared to methods where tracer gases or other tracer materials are used. The present invention allows to dispense with tracer materials.

The invention also comprises:

A method for evaluating a quality of a number of closed filled containers filled with a filling product, said method comprising detecting at least one analyte by means of a mass spectroscopy technique, wherein said at least one analyte comprises at least one of
said filling product;
one or more components of said filling product;
a decomposition product of said filling product;
one or more decomposition products of one or more components of said filling product.

Further embodiments of this method are disclosed in the Patent Claims, particularly in the claims depending on claim 1.

The invention furthermore comprises:

A method for determing a leak tightness of a number of closed filled containers filled with a filling product, said method comprising detecting at least one analyte by means of a mass spectroscopy technique, wherein said at least one analyte comprises at least one of
said filling product;
one or more components of said filling product;
a decomposition product of said filling product;
one or more decomposition products of one or more components of said filling product;
   in particular wherein said method comprises determing said leak tightness from a result of said detecting, and in particular wherein said method is carried out in an in-line fashion following a closing step for closing said containers.

And the invention also comprises further embodiments of this before-addressed method, namely those having in addition features corresponding to features of an embodiment of the first-addressed method.

The invention furthermore comprises:

A method for in-line leak-testing closed filled containers filled with a filling product, comprising for each of said containers the step of detecting at least one analyte by means of a mass spectroscopy technique, wherein said at least one analyte comprises at least one of
said filling product;
one or more components of said filling product;
a decomposition product of said filling product;
one or more decomposition products of one or more components of said filling product.

And the invention also comprises further embodiments of this before-addressed method, namely those having in addition features corresponding to features of an embodiment of one of the before-addressed methods.

The invention furthermore comprises:

A method for manufacturing closed filled containers filled with a filling product, comprising for each container to be manufactured the steps of
filling the respective filling product into the respective container or into a portion thereof;
closing said respective container;
extracting material from an environment of said respective of container;
guiding said extracted material to a mass spectrometer;
detecting by means of said mass spectrometer at least one analyte in said extracted material;
   wherein said at least one analyte comprises at least one of
said filling product;
one or more components of said filling product;
a decomposition product of said filling product;
one or more decomposition products of one or more components of said filling product.

And the invention also comprises further embodiments of this before-addressed method, namely those having in addition features corresponding to features of an embodiment of one of the before-addressed methods.

The invention furthermore comprises:

A use of a mass spectroscopy technique, namely for evaluating a quality of a number of closed filled containers filled with a filling product by detecting at least one analyte by means of said mass spectroscopy technique, wherein said at least one analyte comprises at least one of
said filling product;
one or more components of said filling product;
a decomposition product of said filling product;
one or more decomposition products of one or more components of said filling product;
   in particular comprising extracting material from an environment of each of said number of containers or from an environment of two or more of said number of containers, and detecting said at least one analyte in said extracted material.

And the invention also comprises further embodiments of this use, namely those having in addition features corresponding to features of an embodiment of one of the before-addressed methods.

The invention furthermore comprises:

An apparatus for evaluating a quality of closed filled containers filled with a filling product, said apparatus comprising a mass spectrometer adjusted for detecting at least one analyte, wherein said at least one analyte comprises at least one of
said filling product;
one or more components of said filling product;
a decomposition product of said filling product;
one or more decomposition products of one or more components of said filling product.

Further embodiments of this apparatus are disclosed in the Patent Claims, particularly in the claims depending on claim 41. And the invention also comprises further embodiments of this apparatus, namely those which in addition have features corresponding to features of one of the before-addressed methods or of the before-addressed use.

The invention furthermore comprises:

A production line for producing closed filled containers, comprising at least one apparatus according to the invention.

Further embodiments of this production line are disclosed in the Patent Claims, particularly in the claims depending on claim 48. And the invention also comprises further embodiments of this production line, namely those which in addition have features corresponding to features of one of the before-addressed methods or of the before-addressed use.

It is to be noted that the invention also comprises embodiments of the above-described methods and embodiments of the above-described use, namely those which have in addition features corresponding to features of one of the before-addressed apparatuses or of the before-addressed production line.

The present patent application discloses all embodiments of any of the addressed methods, of the addressed use, of the addressed apparatus and of the addressed production line which have features identical with or corresponding to features of any more explicitely disclosed embodiment, irrespective of that embodiment being an embodiment of any of the addressed methods, of the addressed use, of the addressed apparatus or of the addressed production line.

### BRIEF DESCRIPTION OF DRAWINGS

FIG. 1 is a schematic diagram generically showing processing steps according to the present invention.

FIG. 2 is a schematic diagram generically showing processing steps in the analyzing or testing step in FIG. 1 where a pre-conditioning step of the container, COND, is performed followed by a detection step, DETECT, with a first step to determine whether the container being tested fulfills first conditions and if so followed by a second detection step.

FIG. 3 is a schematic diagram of one possibility of performing the two sub-step detection steps of FIG. 2.

### DETAILED DESCRIPTION OF THE INVENTION

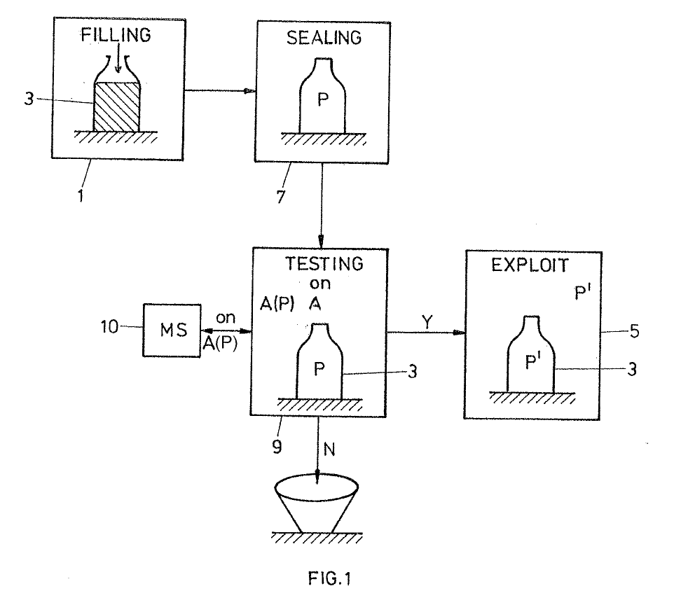

Although the invention being amply described and taught in the summary of the invention as well as in the claims, it shall be further exemplified with the help of figures. According to FIG. 1 there are most generically shown processing steps according to the present invention. In a step 1 addressed by “FILLING” a container 3 is filled with the product. If the filling product is not exclusively gaseous, there may or may not remain in the container 3 a space as shown in FIG. 1 filled with a gas. Irrespective of the fact whether the container 3 is filled with a gas, a liquid or a solid, we address the overall content of the container after the filling step as filling product P. As may be seen in FIG. 1 a container 3 which has passed through processing according to the present invention is exploited in the step addressed by “exploit” 5. The product P′ which is exploited from container 3 according to step 5 for a respective use is the product P which is present in the container 3 after the filling step 1 and sealing step 7. This as if such container was not subjected to the testing step 9 according to the invention but such container was filled, sealed and then just led to exploitation as e.g. delivered to a consumer.

We call such product a “consumer product”.

In other words no product is added to the container 3 which would be specifically provided to perform the specific processing step 9 according to the present invention. After the container 3 has been filled with the addressed product P the container is sealed as schematically shown in FIG. 1 by a sealing step 7. Such sealing is maintained during the subsequent processing step 9 up to exploitation in step 5. After performing the sealing step 7 the container is subjected to the analyzing or TESTING step 9. In this test or analyzing step 9 there is investigated, whether product P as contained in the container after sealing step 7 or possibly a product which results from the product contained in the container 3 has an impact on the atmosphere A which surrounds the container 3 subjected to step 9. Thus, we may address the addressed testing to be performed upon the atmosphere A which surrounds, during performing testing or analyzing, a sealed container 3 with respect to the fact whether the product P or a reaction product of product P has a material impact on atmosphere A. Such impact is dependent from product P and is thus addressed in FIG. 1 by the function A(P).

If the analyzing or testing step 9 reveals by its result that the container does not fulfill predetermined conditions with respect to leakiness, then such container is rejected as addressed in FIG. 1 by the output arrow N for “no”. Only if the addressed container having been analyzed or tested fulfils—Y—the addressed conditions, then it is freed for exploitation in generic step 5.

As has been addressed already before, the present invention resides on analyzing presence of a potential impact on atmosphere A dependent from product P, A(P) by means of mass spectroscopy technique. Thus, the analyzing or testing step 9 of FIG. 1 includes or comprises mass spectroscopy—MS—analyzing so as to finally conclude upon exploitability of the container—Y—. Please note that the product of the container as exploited—step 5—needs not necessarily be equal to the product in the container as sealed—step 7—due to possible container internal product reaction. Therefore, the product is addressed by P′ in step 5.

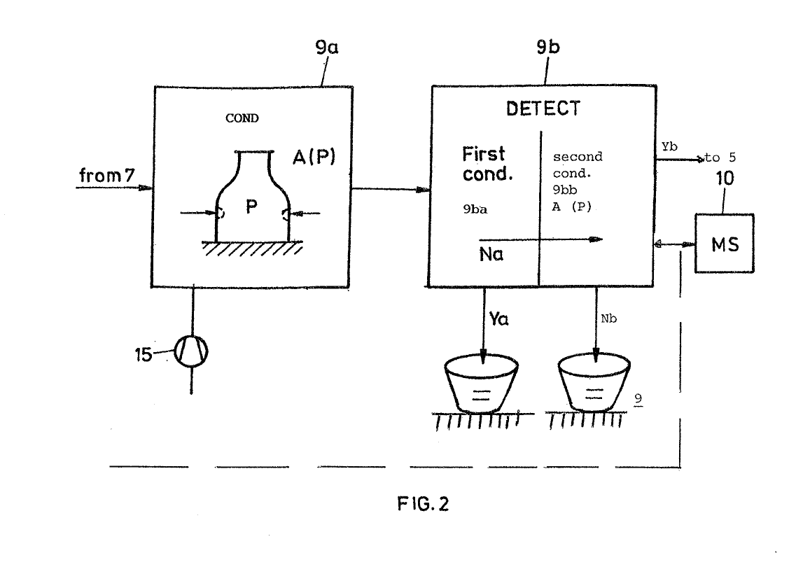

Nevertheless and as will be schematically and principally explained in context with FIG. 2, it might be that a container analyzed in step 9 of FIG. 1 is considered not fulfilling first predetermined conditions before an analyzing step by mass spectroscopy is at all applied to check on second predetermined conditions. Let us make an example: If a container under test is heavily leaking it might be advisable not to have such container to interact with the mass spectroscopy equipment so as not to overload such equipment by extensive amount of product pouring out of the container, but to detect first, whether the container is or is not heavily leaking (first predetermined conditions) and only to activate mass spectroscopical analyzing if no large leak is detected.

FIG. 2 most schematically and generically addresses such processing. After having performed the sealing step 7 as of FIG. 1 the testing or analyzing step 9 is performed. According to FIG. 2 this testing or analyzing step 9, as an example, comprises pre-conditioning the container as shown in step 9a named “COND”. In this step e.g. in a testing chamber (not shown) the container 3 is e.g. pressurized which may e.g. be performed by mechanical pressurizing members as shown at 13, if at least a part of the container wall is flexible. A second example of such conditioning in step 9a is evacuating the surrounding A(P) of the container 3 as by a vacuum pump 15.

After performing such conditioning step 9a the container is subjected to the detection step 9b of the overall testing or analyzing step 9. Thereby, as schematically shown in FIG. 2 as a first stage 9ba of the detection step 9b there is first detected whether the container being tested fulfils first conditions, e.g. has a large leak. If there is detected that these first conditions as preestablished are fulfilled—Ya—e.g. the container has leakage in excess of a predetermined threshold amount, then the container addressed is rejected. If the container being tested does not fulfill the addressed first condition, e.g. has no “large leak” and is thus tight within the frame of the predetermined first tightness conditions, such container—Na—is subjected to the second detection step 9bb, which step is performed by mass spectroscopically—10—analyzing the surrounding A(P) of the container. Only then the mass spectroscopy is exploited for analyzing the surrounding A(P) of the container. If and only if such mass spectroscopical analysis reveals that the container fulfils the second predetermined conditions, e.g. having a leakiness below predetermined extent, such container as addressed by Y_{b} is freed for further exploitation according to step 5 of FIG. 1, otherwise as addressed by N_{b} it is rejected.

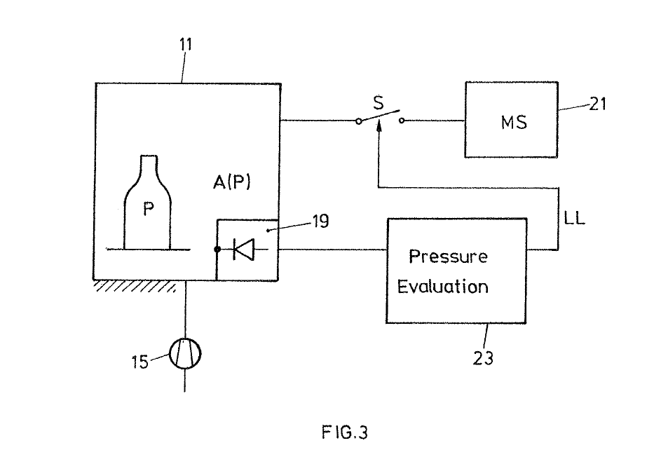

In FIG. 3 there is again most schematically shown one possibility of performing the two sub-step detection steps 9b as of FIG. 2. The container has been conditioned according to step 9a of FIG. 2 by evacuating in a testing chamber 11. Operationally connected to the testing chamber 11, there is provided a pressure sensor arrangement 19 as well as the mass spectroscopic equipment 21. The sub-detection step 9_{ba} for large leak detection is performed by evaluating the pressure course in the surrounding A(P) of the container 3. This is addressed in FIG. 3 by pressure evaluation 23. With respect to such pressure evaluation we e.g. refer to the U.S. Pat. No. 5,907,093 and/or U.S. Pat. No. 6,305,215, both of the same applicant as the present application, which are with respect to large leak detection of liquid-filled containers to be considered as integrated part of the present description by reference.

Back to FIG. 3: If by pressure evaluation 23 there is detected leakiness in excess of a predetermined amount and as addressed by “LL” in FIG. 3, operational connection S of the test chamber 11 to the mass spectroscopical equipment 21 is disabled. Only if by pressure evaluation 23 there is detected no large leak in the sense as addressed above, then operational connection S of the test chamber 11 to the mass spectroscopical equipment 21 is enabled, i.e. S in FIG. 3 is closed.

As was addressed above, containers which are filled and sealed shall be tested or analyzed according to step 9 of FIG. 1 in line, i.e. the containers are conveyed in a stream. This necessitates making use of a mass spectroscopical equipment, which allows short-time subsequent analyzing. At the present moment it has been found that a SIFT-mass spectrographic technique as addressed in the enclosed papers is most suited to be applied in the present invention:
A: SIFT-MS selected ion flow tube mass spectrometry
B: voice 200, data sheet
C: Real-time resolution of Analytes, without . . . March 5h, 2004, Syft Technologies Ltd.
D: voice 200, SIFT-MS at its best,
E: From flowing afterglow to SIFT-MS . . . Feb. 24, 2004, Syft Technologies Ltd.

Further, attention is drawn to the DE 33 40 353 which teaches leak detection by mass spectrography and—in opposition to the present invention—by a tracer gas, which is filled to container specifically for testing purposes.

1. A method for evaluating a quality of a number of closed filled containers filled with a filling product, said method comprising detecting at least one analyte by means of a mass spectroscopy technique, wherein said at least one analyte comprises at least one of
said filling product;
one or more components of said filling product;
a decomposition product of said filling product;
one or more decomposition products of one or more components of said filling product.

2. The method according to claim 1, wherein said detecting is carried out for each of said number of containers.

3. The method according to claim 1 or claim 2, wherein at least one said analyte is detected in material that escaped from one of said number of containers, in particular wherein said material is a fluid, more particularly a gas.

4. The method according to one of the preceding claims, wherein said analyte is a fluid, in particular a gas.

5. The method according to one of the preceding claims, wherein, if a tracer material is contained in said number of containers, said analyte is different from said tracer material.

6. The method according to one of the preceding claims, wherein said analyte is neither Nitrogen nor Helium, in particular wherein it is also not Argon.

7. The method according to one of the preceding claims, wherein said analyte comprises at least one organic compound.

8. The method according to one of the preceding claims, wherein said mass spectroscopy technique os a quadruple mass spectroscopy technique.

9. The method according to one of the preceding claims, wherein a soft ionization technique is used for ionization in said mass spectroscopy technique.

10. The method according to one of the preceding claims, wherein pre-defined precursors are ionized for generating particles for ionization in said mass spectroscopy technique, in particular wherein water vapor is ionized for generating particles for ionization in said mass spectroscopy technique.

11. The method according to one of the preceding claims, wherein ions used for ionization in said mass spectroscopy technique are generated in a plasma, in particular in a microwave plasma.

12. The method according to one of the preceding claims, wherein ions used for ionization in said mass spectroscopy technique are selected by means of a quadruple magnetic field.

13. The method according to one of the preceding claims, wherein N different species of ions are used for ionization in said mass spectroscopy technique, wherein 1≦N≦6, in particular 2≦N≦5, more particularly 2≦N≦4, even more particularly N=3.

14. The method according to one of the preceding claims, wherein said quality is or comprises a leak tightness of said containers.

15. The method according to one of the preceding claims, wherein said quality is or comprises an age of said containers.

16. The method according to one of the preceding claims, wherein said quality is or comprises a remaining time period before deterioration of said filled product.

17. The method according to one of the preceding claims, comprising determining, in dependence of a result of said detecting, a value indicative of said quality, in particular wherein said determining is carried out for each of said number of containers; and in particular wherein said value is determined in dependence of results of at least or exactly two such detecting steps, more particularly wherein said at least or exactly two detecting steps have been carried out at different times, and in particular wherein said value is dependent on a difference formed from said results of said at least or exactly two such detecting steps, and in particular wherein a pre-treatment is applied to the respective container between said at least or exactly two detecting steps.

18. The method according to one of the preceding claims, comprising determining, in dependence of a result of said detecting, a value indicative of a leakage rate for leakage of said at least one analyte from said containers, in particular wherein said determining is carried out for each of said number of containers.

19. The method according to one of the preceding claims, comprising determining, in dependence of a result of said detecting, a value indicative of a leakage rate for leakage of said filled product from said containers, in particular wherein said determining is carried out for each of said number of containers.

20. The method according to one of the preceding claims, comprising determining, in dependence of a result of said detecting, a value indicative of a tightness of said containers with respect to said analyte, in particular wherein said determining is carried out for each of said number of containers.

21. The method according to one of the preceding claims, comprising determining, in dependence of a result of said detecting, a value indicative of a tightness of said containers with respect to said filled product, in particular wherein said determining is carried out for each of said number of containers.

22. The method according to one of the preceding claims, wherein the method is carried out in an in-line fashion, in particular after a closing or sealing step for closing or sealing said containers.

23. The method according to one of the preceding claims, wherein a mass spectrometer is used for carrying out said detecting which is adjusted for specifically detecting said at least one analyte.

24. The method according to one of the preceding claims, comprising transporting said number of containers on a conveyor.

25. The method according to one of the preceding claims, comprising transporting said number of containers on a conveyor and rejecting containers having a result of said detecting beyond a threshold result.

26. The method according to one of the preceding claims, wherein said detecting is carried out subsequently for different containers, a subsequent detecting step starting within 5 seconds after a start of a previous detecting step, in particular within 1 second, more particular within 0.5 seconds, even more particularly within 0.2 seconds.

27. The method according to one of the preceding claims, wherein said quality is or comprises a diffusion rate of said analyte out of said containers, in particular wherein said quality relates to a diffusion rate of said analyte out of said containers in excess to a threshold diffusion rate of said analyte out of said containers.

28. The method according to one of the preceding claims, wherein said quality is or comprises a diffusion rate of said analyte out of said containers, and wherein said method comprises quantitatively determining said diffusion rate.

29. The method according to one of the preceding claims, comprising detecting at least two of said analytes by means of said mass spectroscopy technique, in particular detecting at least three of said analytes by means of said mass spectroscopy technique.

30. The method according to one of the preceding claims, comprising
guiding material from the environment of each of said number of containers into a mass spectrometer used for carrying out said detecting, in particular wherein said material is extracted from an ambient air environment of each of said number of containers; or
guiding material from the environment of at least two, in particular of two or of three or of four of said number of containers into a mass spectrometer used for carrying out said detecting, in particular wherein said material is extracted from an ambient air environment of said at least two of said number of containers.

31. The method according to one of the preceding claims, comprising inserting one of said containers or a portion thereof into a test chamber and carrying out said detecting at said test chamber, in particular doing so for each of said number of containers.

32. The method according to one of the preceding claims, comprising for each container of said number of containers:
enclosing the respective container or a portion thereof in a test chamber, said test chamber comprising no further of said number of containers and no portion of a further of said number of containers;
extracting material from said test chamber; and
guiding said extracted material into a mass spectrometer used for carrying out said detecting.

33. The method according to claim 32, wherein a multitude of such test chambers are provided, and wherein at one time, several of said test chambers enclose one container and a portion thereof, respectively.

34. The method according to claim 32 or claim 33, wherein said respective container and said portion thereof, respectively, is exerted to a pre-treatment in the respective test chamber, in particular wherein said pre-treatment is carried out at said respective container before said detecting is carried out for said material extracted from said respective test chamber enclosing said respective container and said portion thereof, respectively.

35. The method according to claim 34, wherein said pre-treatment comprises at least one of
increasing the pressure in said test chamber and/or effecting an overpressure in said test chamber;
decreasing the pressure in said test chamber and/or effecting an underpressure in said test chamber;
purging said test chamber and/or effecting a gas flow through said test chamber;
increasing humidity in said test chamber and/or guiding water vapor into said test chamber;
decreasing humidity in said test chamber;
applying a mechanical force to at least one portion of said respective container, in particular so as to change a pressure inside said respective container and/or so as to deform said respective container;
pushing or pressing at least one solid member against at least one portion of said respective container.

36. The method according to one of claims 32 to 35, comprising letting said respective container and said portion thereof, respectively, remain enclosed by the respective test chamber, in particular doing so for increasing a concentration of said at least one analyte in the respective test chamber with time.

37. The method according to claim 36, wherein said respective container and said portion thereof, respectively, remains enclosed by said test chamber for more than 1 second, in particular for more than 4 seconds, and/or wherein a time during which said respective container and said portion thereof, respectively, remains enclosed by said test chamber is chosen in dependence of a result of said detecting.

38. The method according to one of the preceding claims, comprising at least one of the steps
applying a mechanical force to at least one portion of said respective container, in particular so as to change a pressure inside said respective container and/or so as to deform said respective container;
pushing or pressing at least one solid member against at least one portion of said respective container;
in particular wherein this is carried out before said detecting and/or during said detecting.

39. The method according to one of the preceding claims, wherein at least a portion of said container is at least substantially formed by a foil.

40. The method according to one of the preceding claims, comprising
carrying out said detecting at one or more calibration sample containers, in particular by detecting said at least one analyte in material that escaped from at least one of said one or more calibration sample containers; and
using results thereof for calibration.

41. An apparatus for evaluating a quality of closed filled containers filled with a filling product, said apparatus comprising a mass spectrometer adjusted for detecting at least one analyte, wherein said at least one analyte comprises at least one of
said filling product;
one or more components of said filling product;
a decomposition product of said filling product;
one or more decomposition products of one or more components of said filling product.

42. The apparatus according to claim 41, further comprising a conveyor for transporting a multitude of said containers.

43. The apparatus according to claim 41 or claim 42, further comprising an extraction unit structured and configured for extracting material from an ambient environment, in particular from an ambient environment of said containers, and a guiding unit structured and configured for guiding said extracted material to said mass spectrometer, in particular wherein said guiding unit is or comprises a capillary.

44. The apparatus according to one of claims 41 to 43, comprising one or more test chambers each structured and configured for enclosing exactly one of said containers or a portion thereof and further comprising a handling unit structured and configured for moving at least one container and/or said one or more test chamber so as to accomplish that a respective container or a portion thereof is inserted into a respective test chamber and removed therefrom again.

45. The apparatus according to claim 44, further comprising at least one of
a pressurizing unit structured and configured for increasing the pressure in at least one of said one or more test chambers and/or for effecting an overpressure in at least one of said one or more test chambers;
a vacuumizing unit structured and configured for decreasing the pressure in at least one of said one or more test chambers and/or for effecting an underpressure in at least one of said one or more test chambers;
a purging unit structured and configured for purging at least one of said one or more test chambers and/or for effecting a gas flow in at least one of said one or more test chambers;
a humidifying unit structured and configured for increasing humidity in at least one of said one or more test chambers and/or for guiding water vapor into at least one of said one or more test chambers;
a dehumidifying unit structured and configured for decreasing humidity in at least one of said one or more test chambers;
a unit for applying a mechanical force to at least one portion of said respective container, in particular for changing a pressure inside said respective container and/or for deforming said respective container;
a unit for pushing or pressing at least one solid member against at least one portion of said respective container.

46. The apparatus according to one of claims 41 to 45, comprising an evaluation unit structured and configured for evaluating said quality for each of said containers from at least one detection result obtained by said mass spectrometer by detecting said at least one analyte for the respective container, in particular wherein said evaluation unit is structured and configured for evaluating said quality for each of said containers from at least or exactly two detection results obtained by said mass spectrometer by detecting said at least one analyte for the respective container at different times, in particular wherein said evaluation unit is structured and configured for determining a difference from said at least or exactly two detection results.

47. The apparatus according to one of claims 41 to 46, wherein said apparatus is a container tightness tester.

48. A production line for producing closed filled containers, comprising at least one apparatus according to one of claims 41 to 47.

49. The production line according to claim 48, further comprising a sealing unit structured an configured for closing said containers, in particular wherein said apparatus is connected to said sealing unit by means of a conveyor structured an configured for transporting said containers from said sealing unit to said apparatus.

50. The production line according to claim 49, further comprising a filling unit structured an configured for filling said containers with said filling product, in particular wherein said filling unit is connected to said sealing unit by means of a conveyor structured an configured for transporting said containers from said filling unit to said sealing unit.

51. Use of a mass spectroscopy technique for evaluating a quality of a number of closed filled containers filled with a filling product by detecting at least one analyte by means of said mass spectroscopy technique, wherein said at least one analyte comprises at least one of
said filling product;
one or more components of said filling product;
a decomposition product of said filling product;
one or more decomposition products of one or more components of said filling product;
in particular comprising extracting material from an environment of each of said number of containers or from an environment of two or more of said number of containers, and detecting said at least one analyte in said extracted material.

52. A method for determing a leak tightness of a number of closed filled containers filled with a filling product, said method comprising detecting at least one analyte by means of a mass spectroscopy technique, wherein said at least one analyte comprises at least one of
said filling product;
one or more components of said filling product;
a decomposition product of said filling product;
one or more decomposition products of one or more components of said filling product;
in particular wherein said method comprises determing said leak tightness from a result of said detecting, and in particular wherein said method is carried out in an in-line fashion following a closing step for closing said containers.

53. A method for in-line leak-testing closed filled containers filled with a filling product, comprising for each of said containers the step of detecting at least one analyte by means of a mass spectroscopy technique, wherein said at least one analyte comprises at least one of
said filling product;
one or more components of said filling product;
a decomposition product of said filling product;
one or more decomposition products of one or more components of said filling product.

54. A method for manufacturing closed filled containers filled with a filling product, comprising for each container to be manufactured the steps of
filling the respective filling product into the respective container or into a portion thereof;
closing said respective container;
extracting material from an environment of said respective of container;
guiding said extracted material to a mass spectrometer;
detecting by means of said mass spectrometer at least one analyte in said extracted material;
wherein said at least one analyte comprises at least one of said filling product;
one or more components of said filling product;
a decomposition product of said filling product;
one or more decomposition products of one or more components of said filling product.

55. A method for manufacturing at least one closed container containing a consumer-product and which container does fulfill predetermined leakiness conditions comprising
providing a closed container filled with said consumer-product
establishing, whether such container fulfils at least one predetermined unleakiness condition comprising analyzing a surrounding of said container with respect to an impact on said surrounding from said consumer-product by means of mass spectroscopy.

56. The method of claim 55, further comprising first detecting whether said container has a leak in excess of a predetermined amount and subjecting said container only then to said mass spectroscopy if there is detected that the addressed container has no leak in excess of said amount.

57. The method of claim 56, wherein detection of whether said container has a leak in excess of said amount is performed by evaluating the pressure in a surrounding of said container.

58. An apparatus for detecting leakiness of a container which is sealed and filled with a consumer product, comprising a mass spectroscopy arrangement which is established to analyze a gaseous surrounding of said container with respect to an impact which is dependent on said consumer product.
